(19) United States
(12) Patent Application Publication
(10) Pub. No.: US 2025/0337624 A1
(43) Pub. Date: Oct. 30, 2025

(54) Digital Carrier Radio Receiver

(71) Applicant: Marvin Motsenbocker, Kamijima (JP)

(72) Inventor: Marvin Motsenbocker, Kamijima (JP)

(21) Appl. No.: 19/183,979

(22) Filed: Apr. 21, 2025

Related U.S. Application Data
(60) Provisional application No. 63/638,444, filed on Apr. 25, 2024.
(60) Provisional application No. 63/640,237, filed on Apr. 30, 2024.

(51) Int. Cl. H04L 27/26

(52) U.S. Cl. CPC H04L 27/2602; H04L 27/2647

(57) ABSTRACT

A high speed wireless data receiver for unmodulated signals combines minimum resonance with a zero crossing detector to detect high speed data at narrow bandwidth. Modulated carrier wave radio communications require long wave trains to encode signals, due to resonance induced transients. In contrast, the digital carrier transmission technique described here minimizes tuning resonance transients, allowing communication data bits as short as 1 to 10 continuous photon sine cycles per bit. Selective quenching purification of signals was used by applying resonant structures within negative feedback loops. By minimizing resonance at each stage of a signal chain, bit delays and transients are removed, allowing faster communication speeds.

### CROSS-REFERENCE TO RELATED APPLICATIONS

This application receives priority from U.S. Pat. No. 63,638,444 filed Apr. 25, 2024 entitled Resonance Free Radio Transmitter for High Speed Communications, and U.S. Pat. No. 63,640,237 filed Apr. 30, 2024 entitled Controlled Resonance Radio Reception of Photon Pulses the contents of which are incorporated by reference.

### BACKGROUND OF THE INVENTION

Modern communications encode and decode signals by modulating and demodulating carrier waves. This basic technique was an important advance over the spark transmitter design of 120 years ago. Now, carrier modulation is used for everything, from commercial broadcasts, satellite transmissions, the physical layer of the internet, and even SETI (search for extra terrestrial intelligence). These communication modes require many repeating waves to encode even the smallest bit of information.

Unfortunately, carrier modulation to embed information into sidebands limits communication speed. For example, amplitude shift keying (“ASK”) turns a carrier wave on and off (or up and down) to encode bits. However, ASK has “very poor bandwidth efficiency” and “is not fit for high bit rate data transmission” due to these complications as mentioned in the prior art. See for example https://www.watelectronics.com/what-is-an-amplitude-shift-keying-working-and-applications/.

These communication techniques lack a perspective of electromagnetic energy as discrete photons but are based on pre quantum physics technology of wave action. Thus, radio transmitters generate repeating identical waves upon which a signal is impressed via modulation. In fact, radio energy is synonymous with “radio wave” in our lexicon.

This focus on waves is reinforced by reliance on the Fourier transform, which requires multiple waves to encode and decode each bit of information. Fourier transform theory teaches that as the number of modulated waves in a wave train decreases, the signal bandwidth increases. As the wave train approaches one wavelength long, the electromagnetic signal blows up into infinite bandwidth, and thus cannot be used for communication.

Long wave trains are convenient to manipulate but have their limitations. Early pioneers of radio technology invented frequency filters to select and purify their signals from their long resonance-derived wave trains. They discovered that in the process of filtering their waves with tuning circuits, the filters generated transients and mangled the first and last waves of every modulation change (signal) in a wave train. This signal degradation occurs because resonant devices such as filters temporarily store energy from each wave of a signal. The stored energy from each wave is returned back to the circuit from the filter at a later time. Thus, the filter must ring up and ring down into and out of steady state when responding to each change in a signal. This delays communication. The first and last waves of modulation changes in a signal wave train thereby become useless.

Transient responses of filters used in radio cause signal broadening and delay

The transient distortion problem of resonance was acknowledged by radio pioneers. A. J. Starr, a research engineer at Marconi's Wireless Telegraphy in the 1930s wrote on this topic in his textbook Electric Circuits and Wave Filters published by Sir Isaac Pitman & Sons, Ltd. 1934, 1938. He pointed out that “[f]ilter properties are completely lost in transient conditions.” Furthermore, these transient conditions can last some time as “many cycles come through (the filter) before the current dies down to the very small steady-state value.” (pages 352-353)

D. G. Tucker in 1946 summarized two “rules of thumb” in his book “Transient Response of Filters.” One, “[t]he build-up time of a band-pass filter for an applied signal of mid-band frequency is equal to the reciprocal of the bandwidth in cycles/sec. For a low-pass filter, the build-up time of an applied D.C. signal is one-half of the reciprocal of the cut-off frequency in cycles/sec.” and two “[t]he amplitude of the peak of the transient caused by the sudden application or removal of a frequency outside the pass-band of a band-pass filter is proportional to the bandwidth and inversely proportional to the difference between applied frequency and mid-band frequency.”

A variety of invented resonant filters tradeoff frequency discrimination with smoothness of response to signal transients. As the filter signal discrimination (filter power) improves, the transient behavior gets progressively poorer. All filters absorb and later remit, with some smearing, at later times, energy from signal changes that pass through them. Filters necessarily require extra leading and trailing ends of wave segments for each modulation event of a communication.

Even so called “pulse” communications such as “chirps” used in satellite transmissions are actually wave trains of many cycles having a distorted beginning region and distorted ending region.

A so-called communication pulse is often referred to as a “chirp” because a large number of photon cycles are assembled in time sequence and with varying frequencies, and do not generate pure tones.

Carrier modulation techniques rely on wave theory wherein a signal frequency is mixed and heterodyned with a “carrier” wave train. This creates two sidebands of multiple frequencies that encode the signal information. The carrier often is removed, as well as one of the redundant sidebands. Unfortunately, as more information is added to the wavetrain, the sidebands occupy increased bandwidth.

Accordingly, wave theory, usually in combination with Fourier transform manipulation of signals, which require long wave trains, controls all our communications, including so called “pulse” transmissions. Individual photons on the other hand, considered as particles, occupy much shorter time periods yet are always sequentially grouped into long time trains for radio communication.

To overcome these obstacles, a digital carrier transmitter was discovered as described in priority application 63/638,444 filed Apr. 25, 2024. The digital carrier transmitter generates short pulses of synchronized photons and does not use or require side bands to encode information. That is, transmitted photons are time ordered one after another as distinguishable snippets of a longer wave. Unfortunately, most radio techniques that purify and isolate radio signals require resonance. All attempts to employ a filter for purification failed by causing the separated segments to smear into a long continuous carrier wave train. Thus, the high speed digital carrier transmission technique prompted a need for a receiver that can handle signal detection without highly resonating circuitry often used in antennas, frequency filters, and impedance changers.

### SUMMARY OF THE INVENTION

The digital carrier communication technology described here addresses several under-appreciated limitations in the 100 year old art of radio communication. These limitations are difficult to understand at first glance. For this reason, a theoretical explanation of the problem is reviewed first to help the reader understand the nature of the problem addressed by embodiments.

Digital carrier technology is inapposite to basic teachings in radio engineering but does not violate physics. As cited in the background, problems such as signal delay and the need for multiple waves to encode the simplest bit of information are generally ignored. This also creates the need for the fast Fourier transform to unravel and make sense out of the overlapping and redundant wave information to recover data encoded by multiple waves.

By removing resonance from circuits, faster communication was possible. Unfortunately, this is not easy to visualize or to implement. This is because receivers use signal selection filters, which resonate and destroy the integrity of individual sine waves in order to filter center portions of wave trains between signal changes. A typical narrow bandpass tuning filter cannot properly process individual single sine wavelength long signals.

A compromise was made wherein limited resonance is accepted, typically by using a filter at critical resonance, and by using a small number of wave cycles per bit to accommodate resonance induced signal degradation. This requires a receiver that can detect data bits from very short pulses comprising only a few photon sine waves per bit. The transmitter typically sends 1 megabit per second on the lower ham bands in groups of 5, 10, 50 or 100 etc. photon sine wave segments per bit as described in priority application 63/638,444.

The problem: need to avoid or minimize resonance

All attempts to filter a short, one photon sine pulse length signal in receiver circuits failed due to collapse of the electron wave function and conversion of the energy into a multiple sine wave train due to filter resonance. See, for example FIG. 2 “Effect of bandpass filter on single, multiple pulses” from Direct Current Generation of Radio Wave Photons from an Antenna at https://vixra.org/abs/2310.0123.

This figure illustrates that when a single sine pulse electron wave energy enters a resonating circuit, the isolated electron wave energy is absorbed and signal integrity is lost. Subsequent release of the absorbed energy as a new electron energy wave later in time occurs one or more cycles later. This converts the single pulse of multiple electrons acting as a group into multiple synchronous waves, which appear as a withering wave train.

Generally, receivers comprise multiple resonating filters, which limit the minimum time duration (sine waves) of a bit that can be encoded by the signal. Interstage coupling wherein impedance of one output is changed by an inductor coupled into the next circuit stage also collapses the wave function of the pulse. Even most antennas change impedance via resonation when matching a low 50 ohm impedance (low electric field to high magnetic field ratio) to free space (equal electric and magnetic field energies exhibiting 377 ohms impedance). It was found that every such impedance change and resonance circuit element destroyed the integrity of the digital carrier signal by converting the individual pulses into a longer wave train.

Solution: Control resonance as needed to select a desired signal, and optionally use a zero crossing detector to detect pulses of photons. Ignore or remove sidebands.

### Front end Amplifier/Filter

A single photon duration (i.e. one sine wave long) pulse output from a 10 watt transmitter operating on 10 MHz (the 30 meter wavelength band) contains about 1.5×1020 identical photons. Ideally, a receiver antenna would intercept enough of these photons to generate a one wavelength long bit pulse in a receiver. A zero crossing detector such as a high speed comparator can detect this bit, by converting the zero crossing change into a digital pulse.

It was found that combining a non-resonant antenna with a minimum resonance (i.e. low Q quality factor) tuner can separate a signal from background, allowing detection of bit signals 3 to 10 cycles or more long. By encoding the bit information within a small number of sine cycles less than 100 and preferably no more than 10, the beginning and ending cycles could be destroyed without eliminating the middle bit information.

This process sometimes works best if the tuning circuit has adjustable dampening so that the circuit can be adjusted down to or near threshold dampening (i.e. a Q of ½). Preferably a frequency filter is used having a Q less than 50, more preferably less than 10 and most preferably less than 2. Q can be measured as reactance of the circuit divided by its resistance. Usually resistance is added to the inductor of a parallel resonant circuit to decrease Q.

For example, a 4 megahertz transmission of 5 cycles (i.e. a string length of 5 continuous photon wave durations per bit) allows communication of 800 kilobits per second at this low radio frequency. A 10 megahertz transmission of 10 cycles per bit can likewise accommodate 1 megabits per second. By making each bit occupy a few cycles of photons we can allow operation of a traditional tuning circuit that is modified to get close to resonance threshold, and sacrifice less of the beginning and end cycle(s) of the short train. The key to success here is to make sure that the effects of tuning circuits and impedance matching circuits in the radio do not add up to completely destroy the integrity of all the cycles in the short signal bit.

### Effect of Simple LC Frequency Filter on a Short Wave Train

By way of illustration, a simple LC filter was constructed for a test bit 2.5 us long comprising 10 sine vibrations at 4 MHz. FIG. 1 top half is a schematic of the LC filter 110 connected to the output of a linear transistor amplifier 120. Inductor 130 of filter 110 is connected in parallel with capacitance 140 to present a high impedance to a resonant frequency for signal purification at that frequency. In a first trial, capacitance 140 had a value of 215 pF and inductor 130 was 7.4 uH. L 130 was made from 30 turns of enamel wire over a T50-2 toroid. The coil and capacitor have equal reactance of 185 ohms at 4.0 megahertz. The solid line plot 150 shown in the bottom half of FIG. 1 shows the frequency response of this amplifier/filter to a 10 mV input. This is an example of a preferred amplifier and a preferred resonance filter.

For comparison, the frequency response was repeated in a second trial with a sharper filter (higher Q) with capacitance 140 at 530 pF and inductor 130 at 3.0 uH. L 130 was made from 21 turns enamel wire around the T50-2 toroid. This also resonates at 4 MHz as both capacitor 140 and inductor 130 have the same reactance of 18 ohms at this frequency. The dashed line plot 160 shown in FIG. 1 bottom shows the frequency response of this amplifier/filter to the same 10 mV input. A comparison of these two plots in FIG. 1 shows that the second filter has a stronger filtering response with a narrower bandpass. The second filter was used in examples of double filtering a received 4 MHz signal.

FIG. 2 shows a 4 MHz 10 cycle bit 210 before and the same bit 220 after processing by the preamp-LC circuit of FIG. 1 with the stronger filter. The LC filter deteriorated the 10 cycle bit, but the bit was still recognizable. The problem illustrated via this exercise is that resonance of a filter limits the minimum number of cycles of photons that encode a bit of signal change. This problem occurs with every change in a signal that drives modulation of a carrier wave. Preferred embodiments avoid use of resonant circuits or if used, limit them to operation with their Q less than 2 and preferably less than 0.5.

Accordingly, in an embodiment a communications receiver comprises: at least one linear amplifier that lacks impedance matching at its input and outputs; at least one frequency filter with adjustable Q; and a sine wave detector that accepts a signal that passes through the at least one frequency filter and the at least one linear amplifier and outputs a signal voltage in response to a signal input. In an embodiment the digital receiver further comprises a non-resonant antenna. In an embodiment the digital receiver sine wave detector is a zero crossing detector comprising a comparator. In an embodiment the digital receiver further comprises a buffer that accepts multiple signal voltage outputs from the sine wave detector and temporarily stores the accepted multiple signal voltage outputs for transfer to a computer. In an embodiment the digital receiver comprises at least one bandpass filter and at least 2 narrow band filters for each bandpass filter, wherein the at least one bandpass filter outputs a band signal to the at least 2 narrow band filters for simultaneous detection of at least signals from the bandpass filter.

Another embodiment is a digital receiver comprising at least one linear amplifier connected to a frequency filter circuit; at least one frequency filter circuit that has an adjustable Q; and a sine wave detector that accepts a signal that passes through the at least one frequency filter and the at least one linear amplifier and outputs a signal voltage in response to the accepted signal.

Another embodiment is a digital receiver comprising a band pass filter; a linear amplifier stage following the bandpass filter that amplifies signals that pass the bandpass filter; a second filter that selects a narrower portion less than 1 kHz wide, of the signals that pass the bandpass filter; and a zero crossing detector that creates computer readable pulses from the individual cycles of signals that pass through the crystal filter; wherein the digital receiver does not process the received signal by heterodyning or other carrier wave demodulation process. In an embodiment the digital receiver processes signals in group sizes of 2-10 sine lengths per bit, and the digital radio designates 0 or 1 bit for each group of 2-10 sines.

In an embodiment the digital receiver comprises a minimum strength signal strength detector that selects out for further processing, signals that have a signal strength above a predetermined threshold. In an embodiment the digital receiver minimum strength signal strength detector is a hysteresis of the zero crossing detector. In an embodiment of the digital receiver the zero crossing detector is a comparator and the hysteresis is an adjustable feedback of output from the comparator to the positive signal input of the comparator.

### BRIEF DESCRIPTION OF DRAWINGS

FIG. 1 shows operation of an “LC” (inductor and capacitor) filter in an embodiment.

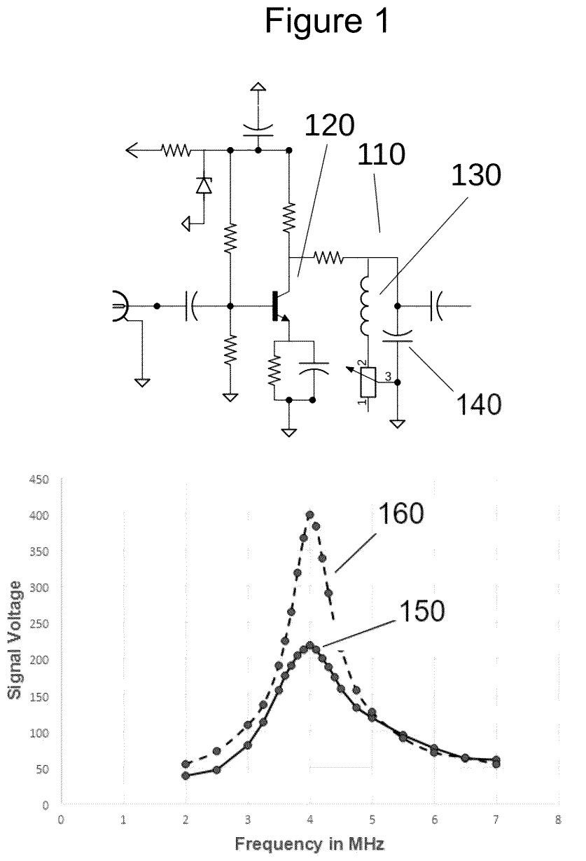

FIG. 2 shows an effect of an LC filter on a 10 sine bit signal.

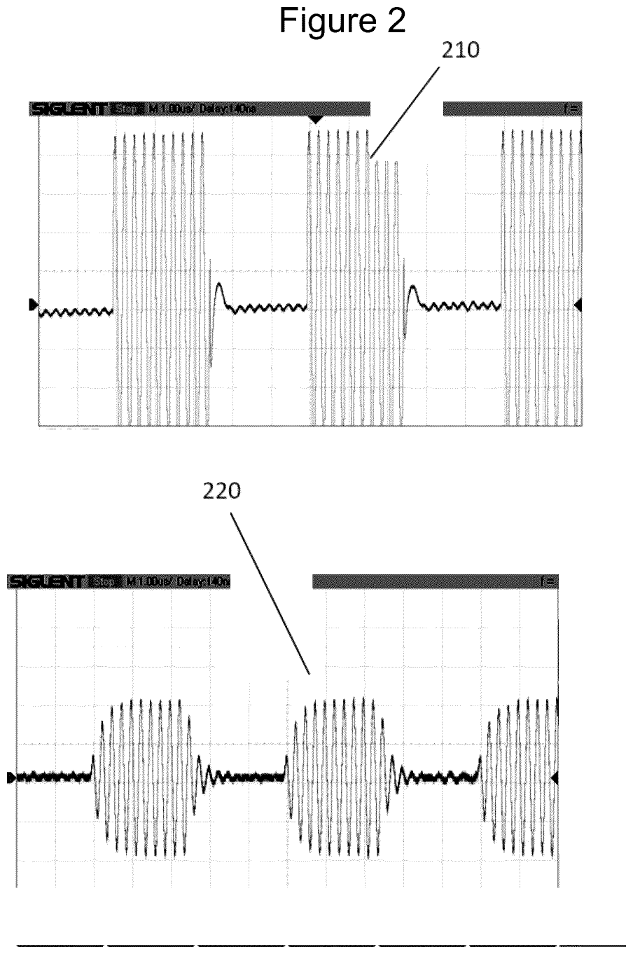

FIG. 3 is a block diagram of an embodiment.

FIG. 4 is a circuit diagram of an embodiment.

FIG. 5 shows a multi-signal receiver embodiment.

FIG. 6 shows a receiver embodiment.

FIG. 7 shows a receiver embodiment.

FIG. 8 shows reception of a 4 MHz signal.

FIG. 9 shows detail of a received signal.

FIG. 10 shows the effect of changing filter Q.

FIG. 11 shows operation of hysteresis on zero crossing detection of digital carrier.

FIG. 12 shows results at 7.3 MHz for an embodiment.

FIG. 13 shows a circuit embodiment.

FIG. 14 shows a block diagram of a radio example. At least one specification heading is required. Please delete this heading section if it is not applicable to your application. For more information regarding the headings of the specification, please see MPEP 608.01(a).

### DETAILED DESCRIPTION OF THE INVENTION

### Basic Plan of the Receiver

Digital receivers and methods for their operation were discovered that lack prior art heterodyning, and resonance based frequency selection and processing circuits. In particular, many embodiments lack one or more (and preferably exclude all of) a. operation of a fast fourier transform algorithm to decipher received signals; b. heterodyne with a local oscillator to create an intermediate frequency or direct conversion signal; and c. carrier wave demodulation to recreate information from a transmitted signal. Such specifically excluded demodulation techniques that are avoided in embodiments include, inter alia, AM demodulation, FM demodulation, phase shift demodulation, frequency shift keying demodulation, quadrature demodulation, and single sideband demodulation.

Another feature of embodiments is the limited use of resonance filtering. Embodiments do not need resonance filtering of a carrier wave that encodes the communication that is received and given to the user. Instead, preferred embodiments eschew carrier demodulation and employ no resonance filtering or minimum resonance filtering of the received signal just enough to separate out an appropriate bit stream of typically 2-100 sines per bit having enough signal strength for digital analysis. Preferably, each of the sines in the bit stream are independently processed, for a more rapid communication. Preferably a selective quenching filter is used at one or more locations in the circuit for frequency selection.

Another desirable embodiment is the reception and use of very narrow spectrum signals without side bands. Because side bands are ignored or avoided, and demodulation is avoided, necessary signal width is dominated by stability of the transmitted “carrier” signal. Preferably in an embodiment the transmitted signal bandwidth is less than 1 khz wide, more preferably less than 250 hertz wide and yet more preferably less than 100 hertz wide.

Residual sidebands in the transmitted signal are undesirable and can be further removed by a non-resonant addition or differential comparison circuit such as in Example 3.

In preferred embodiments a minimum resonance filter is controlled to decrease its Q to a level suitable for signal recovery but not more than this. Preferably a regular filter such as an LC crystal or SAW filter is used with added resistance to decrease the filter Q to a level that minimizes interference with pulse recovery. Adding resistance to the inductor side of an LC filter was most convenient. The amount of resistance is within a factor of 10 from the calculated inductor reactance at the frequency of interest. More preferably the resistor is between 1 to 3 times this value. Preferably this resistance is decreased to a value just enough to provide a suitable signal for detection of sine wave crossings by a zero crossing detector. In an embodiment a limited resonance filter is avoided by relying on the antenna to filter out competing signals or by using another techniques such as digital filtering.

After some optional preliminary filtering the signal is passed to a zero crossing detector (“ZCD)”, which in a preferred embodiment comprises a comparator. The ZCD outputs a signal in response to a zero crossing. The ZCD itself can be driven to distinguish different frequency signals and alleviate the need for heavy resonance filtering of the received signal in two ways.

One, hysteresis of the ZCD can be adjusted to allow the ZCD to only respond to signals above a critical threshold. The threshold can be a voltage level that is set automatically or by user input. Further, multiple zero crossing detectors can be used simultaneously and each tuned to a different hysteresis (trigger sensitivity to minimum signal strength).

Two, the frequency and phase of the “carrier” can be detected by sampling the received signal to create a local clock in sync with the received signal. This clock instructs the ZCD to look for crossing only during a narrow portion of time. Preferably the clock signal is created by sampling the signal, amplifying a portion of the sample and outputting the amplified signal portion into a resonant circuit tuned for the desired digital carrier frequency. This passive local resonator will be driven in frequency and phase by a received “carrier.” By using a crystal for this, the receiver can be instructed to only detect digital carrier signals that are close enough to the resonant frequency to cause crystal ringing.

This ringing can be amplified, preferably controlled by an automatic gain control and converted into a sine wave that can be sampled at various heights of the sine. The sampled output corresponding to different time points of a sine cycle preferably triggers an analog switch that connects the signal to the ZCD detector input for only a short time. By sampling the clock at a region near the zero crossing time, other frequencies and phases having different crossing times are ignored. In practice it is best to adjust the sampled clock to be 180 degrees out of phase with the received carrier signal.

By using a combination of hysteresis control and ZCD window input control the ZCD can carry out much of the receiver selectivity. For a broadcast band with known local frequencies such as the AM broadcast band, this can overcome the necessity of further frequency selection when tuning into the strongest local station.

Other combinations of one or more near-critical resonance filters, selective quenching filters, hysteresis cutoffs and sample timing control are contemplated as will be readily apprehended by a skilled artisan. A ZCD hysteresis or phase and time sampling controller can automatically adjust the Q of a resonant circuit by altering a resistance added to bring the resonator closer to or further from critical resonance according to the need for separation from other frequencies. In response to detection of lower inter channel interference, the amount of resistance added to a resonant filter would be automatically increased. The increased resistance lowers the filter performance, which permits more background noise but also interferes less with the received bitstream. This strategy is preferred for highest speed operation, although non adjustable filters can be used.

This technique can also be used for simultaneous reception of two signals at the same frequency but at different phases such as 180 degrees apart. A first ZCD input window is set to look for zero crossing at one phase of the carrier signal and a second ZCD input window can be set 180 degrees out of phase with the first ZCD window. A skilled artisan radio electronics engineer with 3 years experience with analog and digital circuits will readily apprehend further permutations of using one or several ZCDs. Further permutations are not listed here for brevity.

In a preferred embodiment a medium wave (<3 MHz, preferably between 0.5 MHz to 2 MHz) receiver comprises one or more frequency filters, preferably LC filters, to select a strong signal station. The receiver further lacks demodulation circuitry such as heterodyning or demodulation detection of a carrier wave. The LC filtered signal instead is processed by a zero crossing detector such as a comparator, which outputs bit information. Preferably the comparator hysteresis, such as positive feedback, is adjustable. Preferably the hysteresis is increased to select out stronger signals from weaker ones.

In this way, the signal to noise ratio for a radio transmitter station can be increased, while selecting for the strongest local station. Such selection is helpful when searching for weather and road condition information from the closest transmitting station and weaker stations preferentially are excluded. This system is particularly useful for road traffic from most local AM broadcast band stations having known, fixed frequencies.

Embodiments eschew prior art wave train demodulation and detection

In preferred embodiments modulated waves are not demodulated, heterodyning is not used and the digital carrier signal is detected by a zero crossing detector. Preferably a receiver connects to a non-resonant antenna such as a rhombic antenna although a resonant antenna detuned to limit resonance can be used to select a band of multiple frequencies. For example, a ferrite bar inductance antenna or simple vertical can be combined with an optional capacitance and with a resistance to circuit ground. A skilled artisan can determine circuit values to achieve near critical resonance (preferably less than Q=2) and can filter a desired medium wave signal. The incoming signal from the antenna can be further processed by a filter to select one frequency and remove nearby frequencies as described in the last example. Control of the ZCD as described above can also be used to select one station from the band. In this case however, the antenna output may be connected at an unusually low impedance of less than 2000 ohms, and preferably between 200 and 900 ohms.

For implementation in the VHF or UHF bands a non-resonant antenna such as a directional rhombic antenna is preferred. Signal selection can be further enhanced by antenna switching using multiple antennas and/or antenna portions.

Hybrid receiver of limited resonance allows very short trains of data bits

In an embodiment short wave trains of typically 1-10 photon sine wavelengths long are received by a receiver having limited resonance filter(s). In particular, limited resonance means that the total of resonance, including the antenna, impedance matching (if used), mixers, and filters together are limited to allow detection of a 5-sine wave long signal, or other short train of up to 100 sine long. In an embodiment of a strong local signal, this means no more than 3 db purification over background (nearby frequencies outside the passband). In another embodiment this means no more than 10 db over background. In yet another embodiment this means no more than 20 db over background. The term db refers to relative power levels and can be measured by comparing voltages from different signals over a constant reactance load. Preferably this measurement is carried out by sweeping a sine wave over various frequencies across a filter under test. The endpoints where sensitivity drops below 3 db of the maximum center frequency define the bandwidth.

The diminimus signal filtering is in part possible via combined use of digital processing following detection of pulses. A computer for example can look for pulses of a certain frequency. The detector such as ZCD can discriminate large local signals from background to add selectivity. For example, by increasing the hysteresis in a ZCD, the largest signal in a signal mix can be purified away from smaller signals. This latter approach is particularly advantageous when using to tune in local broadcast stations of constant relative signal intensity wherein the strongest signal is desired.

A type of ZCD has been used for demodulating FM radio signals but this differs as requiring long wave trains of phase changed frequency modulated signals as exemplified by US20050201490A1. Also that prior art ZCD employed modulation of signals by their phase.

### Modified AM Radio Embodiment

In an embodiment an existing technology AM broadcast transmitter that broadcasts an uninterrupted carrier frequency signal plus amplitude modulated sidebands is modified to broadcast digital information via the information carrier. In this embodiment sideband energy is separated from carrier signal energy output at the transmitter. The sideband energy output is connected to resonant antenna(s) as is well known. Most or all of the carrier energy is separately processed as a digital carrier using non-resonant circuits and fed to a non-resonant transmitter antenna. The digital carrier and the sidebands, while separately transmitted would be received simultaneously by the receiver. This is preferred at low wavelengths of greater than 100 meters (3 MHZ) and particularly at 300 meters (1 MHz). At these long wavelengths, phase differences between transmitter antennas at slightly different locations are minimized.

At the receiver, the carrier is separately processed as a digital signal using non-resonant or minimally resonant circuits as described herein. Regular existing AM radio technology would receive the digital carrier and naturally convert it to a continuous wave train, by operation of multiple resonant circuits, allowing demodulation for regular AM reception. A receiver that uses non-resonant or limited resonance techniques as described here can detect and store digital information. A digital processing circuit can be added to an existing radio and use the existing antenna if the antenna and its coupling circuit were modified to minimize resonance.

In a digital computer embodiment, the frequency filter is replaced in part or in total, by an analog to digital converter that feeds a computer that runs an algorithm to find a bit pulse. The algorithm does at a minimum, two things. One, the computer looks for repetitive signals spaced apart by a defined interval that corresponds with expected intervals of the bit pulse sequence. Two, after finding the desired repetition the computer inspects the wave form associated with the repetition and compares signal shape the wave with expected sine shape of the pulse to detect the presence of a sine pulse corresponding to a desired tuning frequency.

Although a 3-8 sinewave length maximum is preferred, longer trains of up to 10 or even 100 sines or more may be employed. In an embodiment the receiver (user equipment) communicates with the transmitter (such as cell phone tower, repeater or other user equipment) by negotiating the use of a longer train length of for example up to 100 cycles in response to poor transmission conditions such as high noise or interference.

In an embodiment resonance is controlled by user selection or automatic control of resistance added to a controlled tuning circuit such as a crystal filter, LC filter or SAW filter. Enough resistance is added to decrease resonance degradation of signals yet allow selection of a transmitted signal from a received background signal. In a preferred embodiment three or more filters are used, and in a more preferred embodiment a selective quenching frequency filter is used as described herein. Preferably different signal chains with different filters, in parallel are switched to handle different channels or different bands. In an embodiment the receiver will automatically switch bands with a different set of filters in collaboration with a transmitter in order to optimize or improve reception. This is particularly advantageous in a self regulated network such as a modern cellphone network.

Preferably a broadband filter precedes a narrow filter. In particular, a simple LC resonant filter can first filter out a range of frequencies within a band while allowing passage of signals at one or more frequencies in that band. Each of the multiple frequencies can be filtered out by a more specific filter for that frequency.

### Example 1

### Outline of a Limited Resonance Receiver

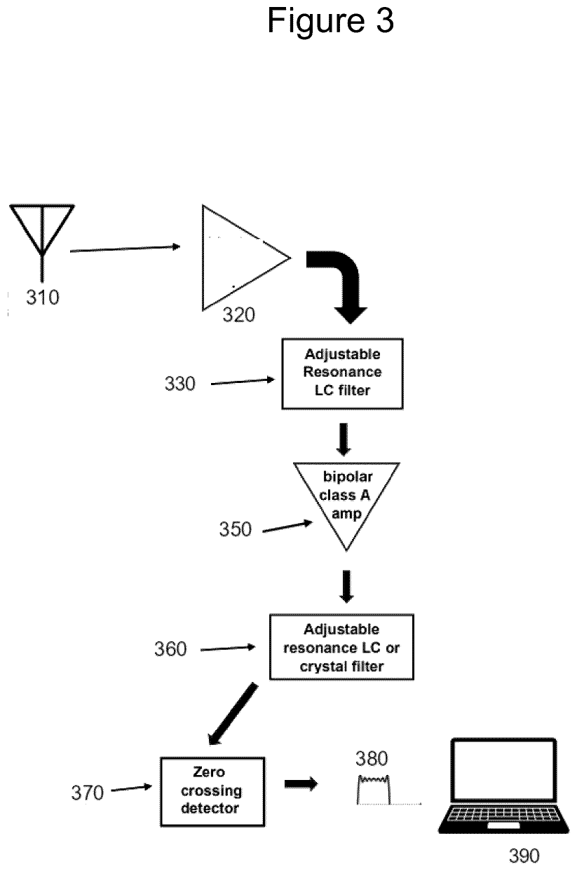

The linear amp-LC filter constructed above was used as a band pass filter in a front end of a limited resonance receiver as outlined in FIG. 3. This figure shows non-resonant antenna 310 that outputs a signal to class A linear amplifier 320, which amplifies and outputs to band selection filter 330. This is followed by another linear amplifier 350, which outputs to a second resonance filter 360. The second resonance filter 360 outputs to zero crossing detector 370. The output from detector 370 is further filtered via hysteresis selection, slope selection and the like to produce signal 380, which enters computer 390.

Non-resonant antennas, also known as traveling wave antennas, are characterized by forming during reception, a forward-moving wave without the formation of standing waves. This means that in non-resonant antennas, only forward waves exist, and there are no (or insignificant) reflected waves, which is different from resonant antennas where both forward and reflected waves occur. Examples include the Beverage antenna, the tilted terminated folded dipole, the terminated end fed vee antenna, the long, untuned wire antenna and the rhombic antenna. Many regular resonant antennas can perform with reduced reflections and act as a non resonant antenna if electrically connected to a low (less than 1000 ohm) resistance at one or both ends and can work in embodiments.

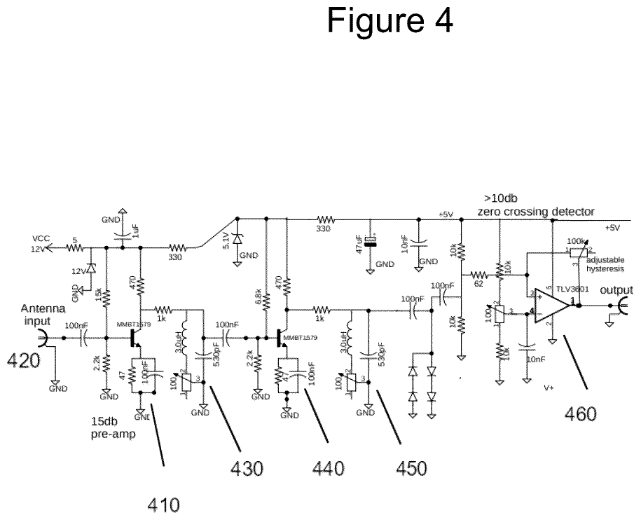

FIG. 4 shows a schematic of a receiver corresponding to FIG. 3 block diagram and used in examples. A signal from non-resonant antenna 420 is amplified 20 fold by linear transistor amplifier 410. The output is filtered by a simple LC band selection filter 430 with optional user Q adjust (not shown) to generate a filtered signal. LC filter 430 contains an FT50-6 toroid with 23 turns enamel wire matched with approximately 530 pF capacitance with a resonance frequency maximum of 4.0 MHz. This is amplified by a second class A amplifier 440, and the output is filtered again by a second filter 450. The signal is then passed to zero-crossing detector 460, which generates a logic TTL (transistor-transistor-logic) level pulse for each cycle received. The zero-crossing detector preferably is a high speed comparator and can provide further filtering via hysteresis control and slope selection. The TTL output can be applied to a shift register or other buffer (not shown).

In embodiments only one amplifier is used and in other embodiments additional amplifiers and filters are used. SAW, BAW and FBAR filters are preferred for many higher frequency embodiments over 50 MHz and especially over 100 MHZ. Resistance may be added to a filter to decrease its Q via a continuous analog control or may be step-wise under control of a microprocessor.

In an embodiment a receiver system comprises a non-resonant antenna connected directly to the first amplifier or filter without any transmission line or adapter or impedance changer. Preferably 50 ohms impedance is not used and preferably an impedance of between 100 and 2000 ohms is used throughout (from antenna to last amplifier) to minimize resonance via collapse of the electron wave function of electron energies created after photon reception at the antenna. Preferably the antenna impedance is 200-500 ohms. The antenna preferably is a non-resonant traveling wave antenna terminated with a resistor opposite the end of attachment to the radio. A rhombic antenna is particularly effective above 30 MHz and a T2FD antenna is preferred at long wavelengths in the shortwave region.

### Example 2

### Simultaneous Reception of Multiple Digital Signals

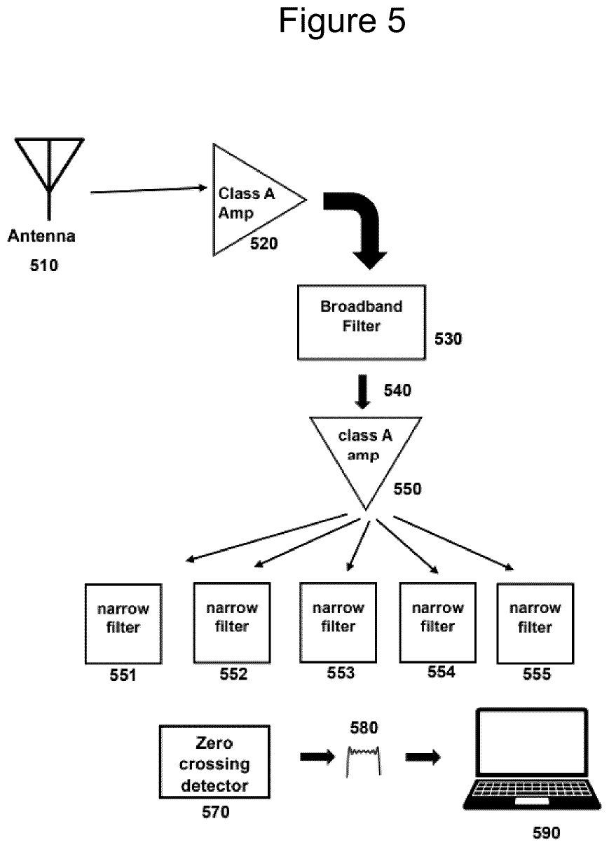

FIG. 5 shows a block diagram of a multiple signal digital receiver. Antenna 510 receives many signals from multiple bands, and optional broadband amplifier 520 presents these to band selection filter 530. Bandpass filter 530 output 540 contains multiple desirable frequencies. Although not shown, other bandpass filters for other bands may be connected in parallel. Output 540 optionally is amplified by linear amplifier 550 which feeds into multiple narrower filter circuits 551 to 555 simultaneously. Each of the outputs from 551 to 555 can be evaluated for the presence of a digital signal such as for example by a zero crossing detector. In this way multiple digital signals can be processed simultaneously from a small segment of a band. A processor 590 combines the bit streams into a usable signal.

Of course, multiple bands and almost any number of specific frequencies can be processed simultaneously. Preferably each signal has a bandwidth of less than 1000 hertz, more preferably less than 500 hertz and yet more preferably less than 200 hertz and even most preferably less than 100 hertz. In an embodiment multiple frequency filters such as SAW, BAW and FBAR filters on a common substrate are used as is known in the cell phone industry for simultaneous filtering. In a more preferable embodiment each filter comprises a linear amplifier having an inverted output as described in Example 6. In an embodiment each channel within a common band is filtered with a narrow filter, generating separate received signals.

### Example 3

### Arithmetic Purification of a Received Signal

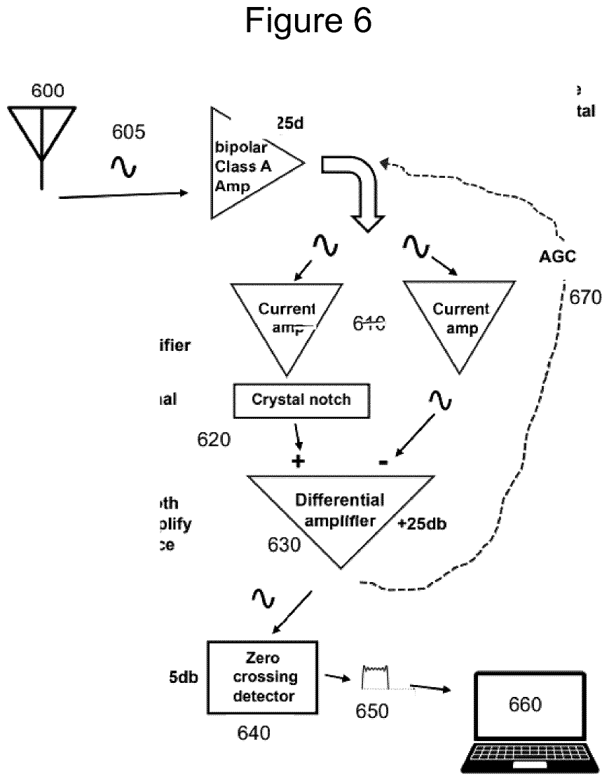

FIG. 6 is a block diagram of an arithmetic method of purifying a desired single sine signal from background with a differential amplifier. Non-resonant antenna 600 receives a single sine signal 605, which is amplified by buffer amplifiers 610. One of these buffers but not the other, contains a notch filter 620 that destroys the single sine by absorbing the single sine. Preferably filter 620 comprises a crystal that resonates at the signal frequency. The 2 channels output nearly identical signals but one lacks the desired signal. Both outputs feed differential amplifier 630, which compares the two inputs and purifies out and amplifies the desired signal, which was destroyed by the crystal notch filter in one of the two channels. Preferably this purified output enters zero crossing detector 640, which creates a logic pulse 650 for use by computer 660 in response to detection of the desired one sine signal.

The two channel signals should be well balanced and for this purpose an automatic gain control 670 is preferred. The AGC is controlled by the differential output amplitude. A high amplitude indicates an imbalance, which feeds back into the AGC to decrease the signal strength in one side or decrease the signal strength in one side.

### Example 4

### Reception of Middle Wave Broadcast Band Digital Signals

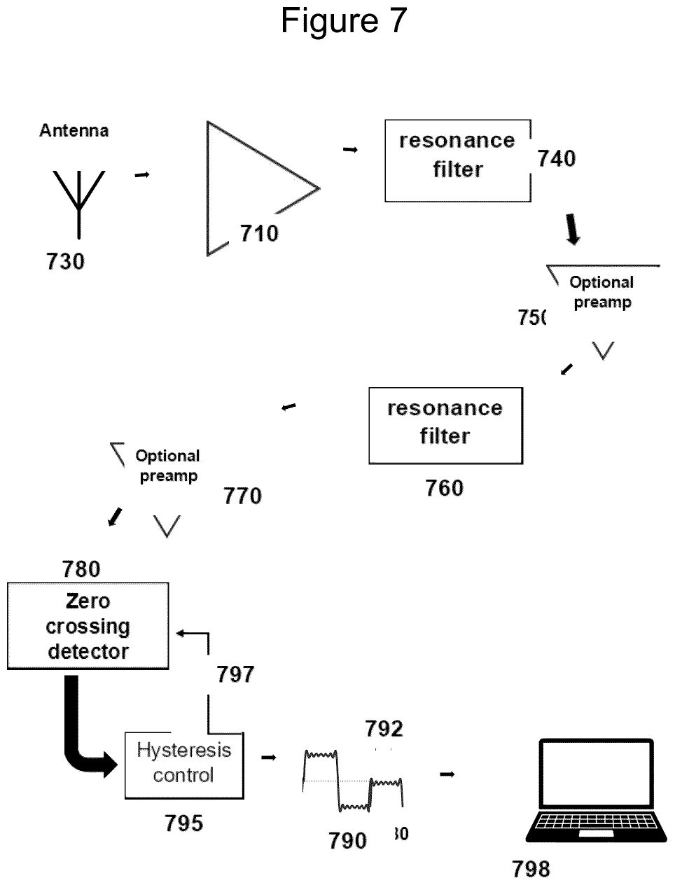

FIG. 7 shows a block diagram for a low frequency broadcast band receiver. Antenna 730 preferably is non-resonant and feeds a signal to optional linear preamp 710. The signal from preamp 710 is filtered by a resonant filter 740, which may be an LC filter. The output from this filter may be amplified and filtered again multiple times by circuits 750, 760, and 770. In a preferred embodiment two filters 740 and 760 are used and the second filter 760 contains introduced resistance in its resonance circuit to lower its quality and thereby partially recover a linear wave form for a short data bit. Preferably the data bit occupies 10 sines or less, more preferably 5 sines or even 3 sines or less. It was discovered that following a first resonance filter with a second filter or even third filter of lower Q due to increased resistance added to an LC circuit, allowed better recovery of sines in the bit signal.

The filtered signal enters zero crossing detector 780, which outputs digital signals for recovery of transmitted information by a dedicated digital processor or computer 798. Preferably hysteresis of the zero crossing detector is adjusted by adjuster 795 to separate pulses of lower energy broadcast signals from higher energy broadcast signals. By increasing the triggering threshold, smaller pulses (right side 792 of signal 790) are removed. This helps the receiver lock onto the strongest station in the area, which is desirable when searching for local weather and traffic information.

### Example 5

### Limited Resonance LC Filtering Receiver

In this example, a double filter receiver was used to detect 10 sine long bit signals from a 4 MHz transmitter. The transmitter is described in pending priority document U.S. provisional application No. 63/638,444 entitled Resonance Free Radio Transmitter for High Speed Communications and filed Apr. 25, 2024.

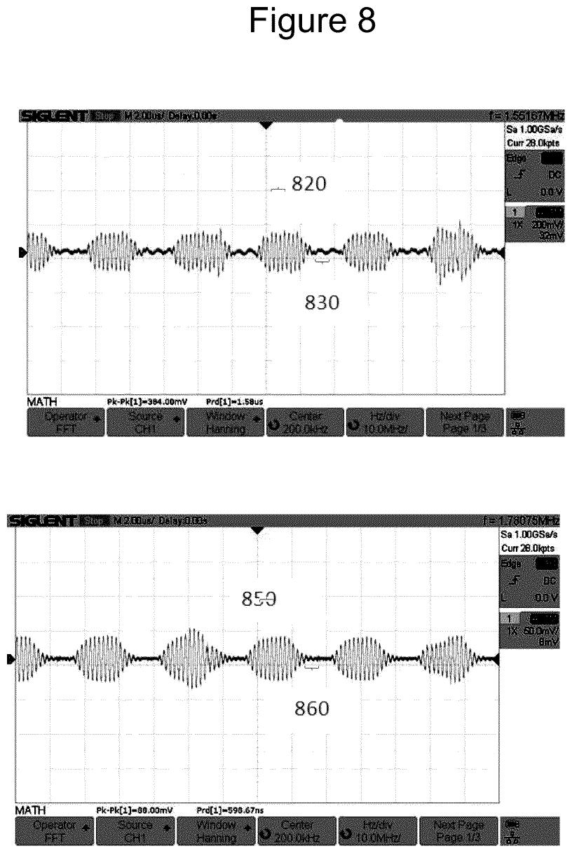

A double resonator circuit was built as described by the schematic diagram of FIG. 4. FIG. 8, top shows an oscilloscope output plot of a received signal after purification by the first LC filter. The 10 sine segments 820 are each separated by no signal segment 830 of equal 10 sine lengths and are visible in this plot. This reveals that the filter smeared the 10 sine segments from segment 820 into segment 830.

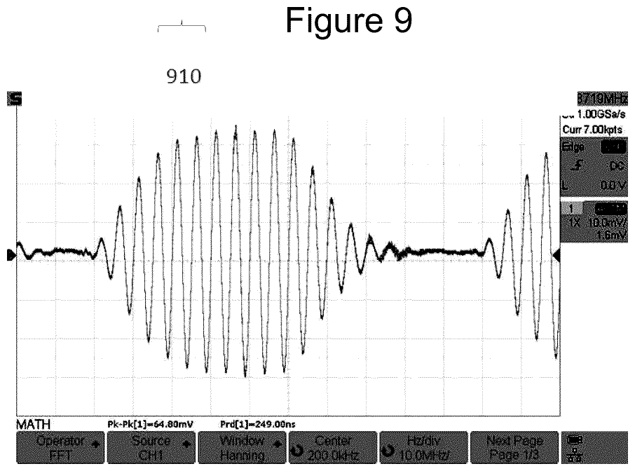

FIG. 8, bottom shows the output from the second LC filter. This shows even more smearing of segment 850 into segment 860, although the 10 cycle long bits are distinguishable from each other. FIG. 9, top shows detail of bit 910 comprising 10 sines. This figure shows that adding a second resonator further rounded off the received bit signal.

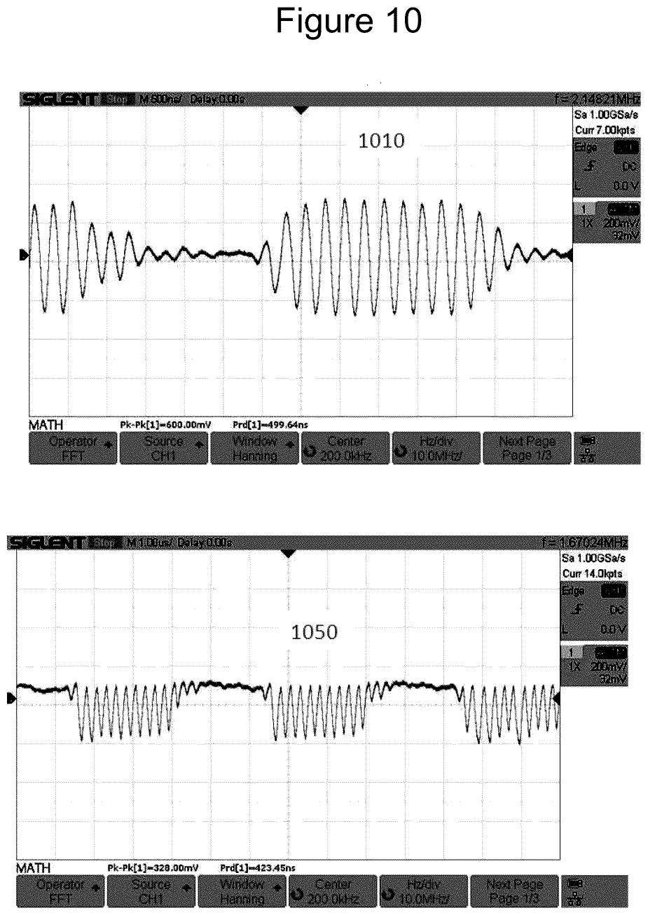

FIG. 10, top shows the effect of decreasing the Q of the second filter by adding 22 ohms resistance in series with the toroid inductor of the second LC filter. The steady state middle region 1010 is now larger and more easily discernable compared to the higher Q version 910 of FIG. 9. This demonstrates the value of decreasing Q of the filter, when the desired signal strength is sufficiently high. The bottom plot of FIG. 10 shows the effect of decreasing the Q even further, with 100 ohms resistance in series with the toroid inductor. As the filter Q drops further, the filter effect has become even more square as seen by the shape of bit 1050. Surprisingly, this shows that adding a lower quality (wider bandpass) filter after a first filter cured some of the effects of the first filter on the multi sine wave shape. Adding resistance to the first filter also improved the linearity of the bit response but at the expense of higher background (not shown).

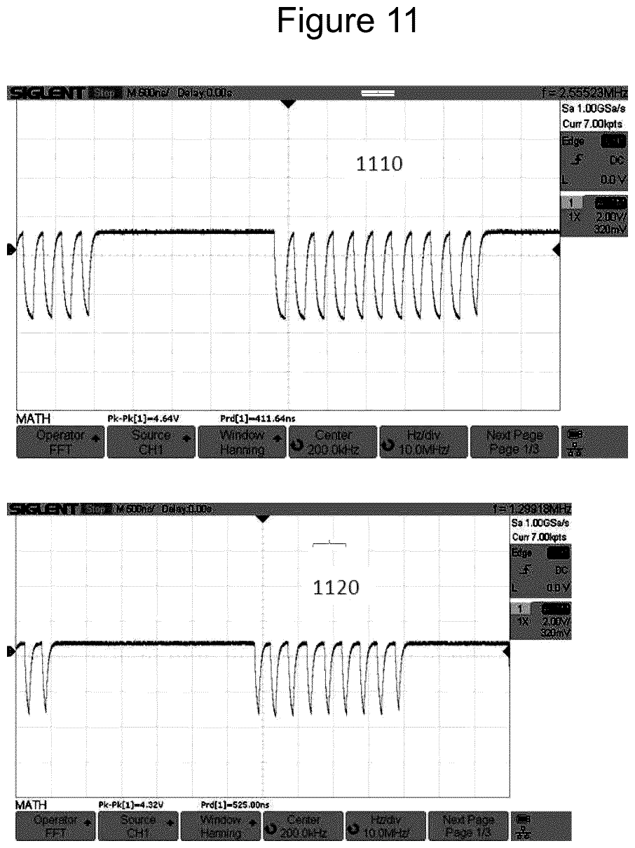

FIG. 11 shows the output response of the zero crossing detector to the twice-filtered bit signal. The top plot shows 11 pulses per bit profile 1110 due to broadening of the bit from the resonant filter. The bottom plot shows an output profile 1120 of 9 pulses per bit for the same signal after hysteresis of the detector was manually increased. Hysteresis was controlled by increasing detector output fed back to the plus input of the zero crossing detector, thus raising the comparator threshold and discriminating against smaller amplified pulses. In an embodiment this hysteresis is carried out automatically by a circuit that monitors total signal output and decreases hysteresis when an average signal decreases. Preferably the automatic circuit itself has a time response of more than 20 pulses.

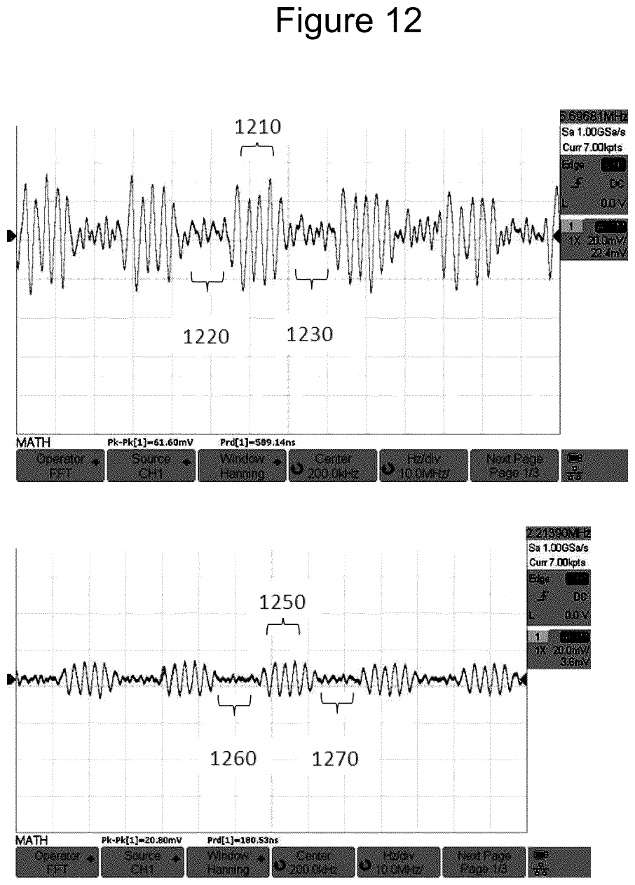

FIG. 12 shows received signals from a 7.3 MHz 5 cycles per bit transmission.

The top plot shows a smooth output bit 1210 from the first filter separated by “0” bits 1220 and 1230 before and after. The bottom plot shows output from the second filter wherein “1” bit 1250 is more clearly separated from 0 bits 1260 and 1270. This demonstrates the value of adding multiple filters such as 2 or 3 filters to create sines that can trigger the zero crossing detector.

### Example 6

### Signal Filtering by Selective Quenching

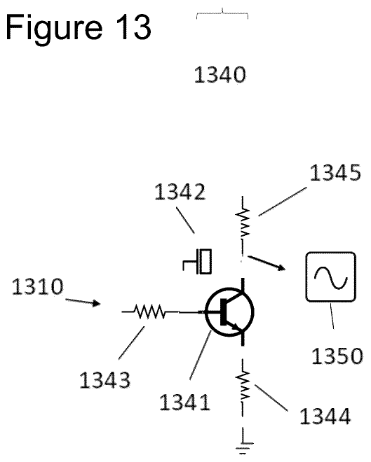

It was discovered that a resonator such as a crystal used in its parallel resonance mode and connected in a negative feedback portion of a transistor circuit could provide high selectivity by selective quenching without causing crystal ringing. This technique works particularly well with linear transistor amplifier circuits that invert the amplified signal. FIG. 13 shows a diagram of a common bipolar amplifier but other transistor types and other amplifier types may be used, provided that a resonator such as a crystal is connected between the inverted output and the input to the amplifier or amplifying element as shown here. During selective quenching, the selected resonant frequency escapes negative feedback. But other, non resonant frequencies are minimized by negative feedback.

The term “parallel resonance mode” refers to the high impedance peak across the crystal connected in series. When using AT cut crystals in the bands below 30 MHz, the parallel resonance frequency is typically about 1 KHz above the crystal's rated frequency. This phenomenon is explained by https://www.analogictips.com/mechanical-vibration-for-electronics-the-quartz-crystal/ It is important that the selective quencher employ a linear, inverting amplifier and not be connected or influenced by another resonator. Connected to the input or output of the selective quencher negative feedback circuit.

FIG. 13 shows inverting circuit 1340 built around transistor 1341. Incoming signal 1310 comprises multiple frequencies, including a desired frequency to be purified. Incoming signal 1310 enters inverted amplifier circuit 1340 via isolation resistor 1343. Transistor 1341 preferably is biased for an amplification ratio of at least 10 and preferably at least 50. Base bias is not shown and emitter (or source) resistor 1344 preferably is bypassed with a capacitor as is customary. The selectively quenched and amplified signal 1350 is taken at the transistor collector-resistor 1345 junction in this case. A skilled artisan can adapt virtually any inverting amplifier to replace amplifier 1340.

This selective quencher filter was made with a 4.000 MHz crystal and successfully purified a 4.0 MHz signal at least 10 fold, and typically 100 fold as seen from a spectrum analyzer of the input signal and output signals. The 4 MHz crystal parallel resonance peak was at 4.001 MHz.

In an embodiment two or more transmitted signals are located at a frequency separation that corresponds to the maximum and minimum reactance peaks (or harmonics of such) of an AT cut crystal. This allows close spacing of signals, preferably between 0.4 kHz to 5 kHz apart at the lower frequency bands, and preferably between 10 kHz and 100 kHz apart in the UHF bands, such as 400 MHz to 1.5 GHz used for cell phones and wifi communications. Preferably the spacings of transmitted and received signals correspond with the natural maximum and minimum reactance of the resonating filter used in the selective quencher filter circuit. In an embodiment this correspondence is within 3 db of the maximum and minimum resonator peaks.

In an embodiment capacitance up to 50 pF is added in series or in parallel with the resonator of the selective quencher filter. Preferably this is adjusted to optimize purification of the carrier from a particular filter. In an embodiment this is adjusted to optimize detection sensitivity of one signal from an adjacent signal, by balancing an increased resonator reactance at a desired frequency with minimizing reactance to an undesirable nearby frequency. Minimizing reactance within the selective quencher circuit to a nearby frequency signal means an increased negative feedback and thus improved rejection of the nearby signal.

These structures and techniques are broadly useful for any application or circuit where it is desired to purify a narrow band signal, (typically less than 500 hertz, more preferably less than 200 hertz) away from nearby signals. A signal is input to the inverting amplifier and taken out of the inverting amplifier with minimum resonance at the connections. It was found that use of a traditional interstage coupling, impedance coupler, or resonating filter in combination with this inverting amplifier failed to work due to excessive resonation of the crystal. Preferably the input and output connections to the inverting amplifier such as shown in FIG. 13 include at least 100 ohms series resistance and more preferably at least 500 ohms resistance.

### Example 7

### Two Stage Digital Receiver

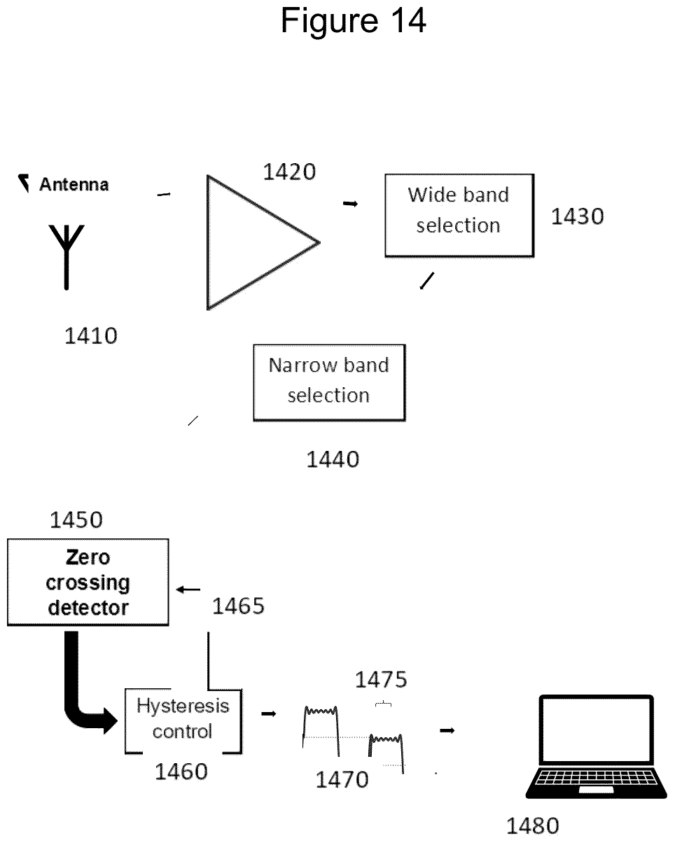

A preferred digital receiver initially filters an incoming signal broadly, and then, in a later stage, applies a narrow filter, as shown in FIG. 14. Non-resonant antenna 1410 senses radio frequency energy. In some embodiments the sensed signal is amplified by optional linear amplifier 1420 before going to first bandpass filter 1430. Filter 1430 has a bandpass of preferably more than 100 KHz. The selected band of frequencies that pass are then filtered by second narrow filter 1440, which may comprise filter circuit 1310 from FIG. 13.

The output of filter 1440 goes to zero crossing detector 1450, which converts zero crossing of sines from the purified signal into digital pulses. Hysteresis control 1460 is preferably used to select only the strongest signals via threshold adjust feedback 1465. Hysteresis control 1460 responds to multiple signals 1470 of different strength by ignoring each smaller one 1475 before passing to computer 1480 or a microprocessor.

In a preferred embodiment first bandpass filter 1430 comprises an LC filter used in parallel resonance mode in a selective quenching negative feedback inverting amplifier circuit and second narrow filter 1440 comprises a crystal used in parallel resonance mode in a selective quenching negative feedback inverting amplifier circuit. These filters exhibit minimal or no resonance to the received signal by virtue of self-extinguishing negative feedback.

The techniques and principles described herein apply to all communications at all wavelengths. The tools and techniques are applicable to other high frequency regions such as VHF, UHF, wifi, cell phone frequencies and the like.

Although embodiments of the invention have been described in detail above with reference to the drawings, a specific configuration is not limited to the embodiments, and designs and the like that do not depart from the essential spirit of the invention also fall within the claims.

1. A digital receiver comprising:
an input to receive radio frequency signals;
at least one frequency filter operably connected to the input that has a Q of less than 5;
at least one linear amplifier; and
a sine wave detector that accepts a signal that passes through the at least one frequency filter and the at least one linear amplifier and outputs a filtered and amplified signal;
wherein the digital receiver lacks demodulation circuitry and does not respond to sidebands in the radio frequency signals to output the filtered and amplified signal.

2. The digital receiver of claim 1, further comprising:
a non-resonant antenna connected to the at least one linear amplifier or at least one frequency filter.

3. The digital receiver of claim 1, wherein the sine wave detector is a zero crossing detector comprising a comparator.

4. The digital receiver of claim 1, comprising a selective quencher frequency filter made from an inverting amplifier with negative feedback, the feedback comprising a parallel resonance circuit portion.

5. The digital receiver of claim 1, wherein at least one frequency filter has an adjustable Q provided by a variable resistance.

6. A digital receiver that receives a carrier frequency to generate a digital result, comprising:
a signal input that produces a received signal for manipulation by other circuits;
at least one frequency filter circuit with a Q below 3 that accepts and purifies the received signal;
at least one linear amplifier that accepts and amplifies the signal; and
a zero crossing detector that creates a digital form of the purified and amplified signal in response to zero crossing of the signal,
wherein the digital receiver lacks demodulation circuitry.

7. The digital receiver of claim 6, comprising a first selective quencher frequency filter made from an inverting amplifier with negative feedback, the feedback comprising a parallel resonance circuit portion.

8. The digital receiver of claim 6, wherein the at least one frequency filter circuit has an adjustable series resistance to modify the filter circuit Q.

9. The digital receiver of claim 6, wherein the zero crossing detector comprises a hysteresis control that allows adjustable selection of different strength signals.

10. The digital receiver of claim 8, wherein the zero crossing detector causes a decrease in the filter circuit Q in response to an increase in level of a detected signal.

11. The digital receiver of claim 6, comprising a first frequency filter that selects a band width of frequencies at least 100 KHz wide followed by a second frequency filter that selects a signal width of less than 3 KHz wide.

12. The digital receiver of claim 11, wherein the second frequency filter selects a signal band width of less than 400 hertz wide.

13. The digital receiver of claim 7, wherein the inverting amplifier is a single transistor amplifier.

14. The digital receiver of claim 7, comprising a second selective quencher frequency filter, wherein the second quencher frequency filter has a crystal and produces a purification with a bandpass of less than 500 Hz.

15. A receiver of broadcast band pulsed carrier radio signals comprising a radio signal input;
at least one frequency filter that filters digital bit signals of between 2 and 20 sine waves at the carrier frequency, per digital bit from the signal input;
at least one linear amplifier for amplifying the digital bit signals; and
a zero crossing detector that outputs a pulse for each sine wave in the digital bit signals of between 2 and 20 sine waves per bit.

16. The receiver of claim 15, wherein the zero crossing detector comprises an adjustable hysteresis that filters out a strong signal from weaker signals.

17. The receiver of claim 15, wherein the at least one frequency filter is a selective quencher circuit comprising an inverting amplifier with parallel resonance in a negative feedback configuration.

18. The receiver of claim 15, wherein the receiver lacks a demodulation circuit.

19. The receiver of claim 15, further comprising a demodulator of sidebands of the digital carrier frequency, and wherein the demodulator produces an analog signal.

20. The receiver of claim 15, further comprising a memory of broadcast station frequencies and locations uses information from this memory to adjust one or more frequency filters.
